(19) United States
(12) Patent Application Publication
(10) Pub. No.: US 2003/0012915 A1
(43) Pub. Date: Jan. 16, 2003

(54) Sheet with indicator lines

(76) Inventor: Chris Skinner, Jamesburg, NJ (US)

Correspondence Address: SOFER & HAROUN, L.L.P., 342 Madison Avenue, Suite 1921, New York, NY, 10173, US

(21) Appl. No.: 09/904,446

(22) Filed: Jul. 12, 2001

(51) Int. Cl. B32B 3/10

(52) U.S. Cl. 428/43; 428/195

(57) ABSTRACT

A configurable background design sheet for attachment to different sized scrapbook pages. The background design sheet is equal or greater in width with respect to the scrapbook page. The background design sheet has a design side and a sizing side that is reversely disposed to the design side. At least one pair of cut line indicia are disposed on the sizing side. The indicia represent the proper spacing of cut lines for the different sized scrapbook pages.

### FIELD OF THE INVENTION

This invention relates generally to a background design sheet, and more particularly, to a configurable scrapbook design sheet having a reverse side that indicates to a user a variety of sizes so that the sheet can be conveniently cut to create a background design sheet that corresponds to a user's standard scrapbooking notebook.

### BACKGROUND OF THE INVENTION

Many people collect photographs, ticket stubs, newspaper clippings and other memorabilia. Oftentimes, groupings of such material are related to one specific event or another. For example, a parent may collect photos of a child's Little League baseball game along with tickets and newspaper articles in connection to the game. Some people choose to keep such objects in a simple shoe box or other similar container. However, over the years, and with growing popularity today, people have been organizing bound albums that hold pictures and the like along with designs and written word. These books are known as “scrapbooks.” Within the art, the term “scrapbooking” has been coined for the activity of keeping and creating scrapbooks.

It is likely that current scrapbooks are an outgrowth of photo albums that originated at the time when photographs first became an accessible to the general public. Scrapbooks are designed to help display memorabilia in an aesthetically appealing fashion. However, in recent years more attention has been given to the preservation of memorabilia. In turn, scrapbooks are often made from special materials that help to ensure preservation of their contents. Most important is the use of acid-free and lignin-free materials. Lignin is a substance that is found naturally in the cell walls of plants. Lignin is largely responsible for the strength and rigidity of plants, but its presence in paper is believed to contribute to chemical degradation.

According to industry figures, scrapbooking has recently become a thriving business amounting to more than $200 million in sales for scrapbooks and scrapbook related products. Further evidence for the current popularity of scrapbooking is demonstrated by the proliferation of books and webpages on the Internet that are related to scrapbooking.

It is commonly known in the art that there are two traditional sizes of scrapbooks. These are scrapbooks with pages that measure 12″×12″ and those books with pages that measure 8½″×11″. Considering such units of measurement are used in few places besides the United States, it can be appreciated that other standards do exist, and that ultimately, any desired size book—within reason—can be made. The pages of a scrapbook are often made from heavy paper and held in a three ring binder or bound in a wire spiral.

Scrapbooking hobbyists often use mats, frames, borders, headers, and backgrounds to decorate individual pages. These articles may be crafted by an individual using the proper tools and paper. Alternatively, an individual may purchase pre-made, pre-fitted decorations. Because these articles are pre-fitted, they are only suitable for certain page sizes—such as the standard sizes discussed above. Large items can be cut to fit smaller pages, but this often results in damaging the design and, as discussed immediately below, it is often difficult to skillfully cut such items in order to prevent under and overlapping the page on which the items are attached.

In order to cut a background sheet so that it will fit on a scrapbook page, an individual is forced to measure out an exact portion of the background sheet that corresponds to the scrapbook page size, which in most cases is a standard size to begin with, in order to properly fit a background design on the page. Often, this sizing of the background sheet takes the form of marking (e.g., with a pen, or other writing instrument) the sheet directly so as to provide the user with guidelines for cutting. These marks may remain on the item when it used. In turn, whether made by the individual or purchased pre-cut, scrapbook items are often difficult to properly size and are difficult to use with a variety of sheet sizes.

U.S. Pat. No. 3,970,397 to Armstrong for a business card system discloses a card that contains printed business material in a field having the area of a standard business card (2×3½ inches) on a larger card (3×5 inches). Perforations or marking provided on the card predetermine where areas of the large card are to be severed from the remainder to size the resulting card for use with an of several card filing systems. By preference, a plurality of parallel lines of the perforations or markings and an adjacent edge are bordered with generally T-shaped slots so the resulting card may be filed on standard roll, wheel and arched tray-type index card holders of a plurality of different size formats.

There is no known convenient solution to the problem that arises when one wishes to fit background design sheets onto a scrapbook page. Thus, there is a need for a background design sheet that can be easily configured to fit on a variety of scrapbook pages and provide a user with a helpful means for sizing the background design sheet to fit popular scrapbook sizes.

### OBJECTS AND SUMMARY OF THE INVENTION

It is a primary object of the present invention to provide a background design sheet that can be used with a variety of scrapbook pages that are sized differently.

A more specific object of the present invention is to provide a background design sheet that includes a means for aiding a user to cut the background design sheet so that it may fit on a variety of differently sized scrapbook pages.

It is another object of the present invention to provide a background design sheet that is relatively simple to construct and economical to manufacture.

It is a further object of the invention to provide a background design sheet wherein all cutting occurs on the rear face,—the non-designed sizing side of the background design sheet—thereby leaving the design side unmarred after sizing.

Thus, according to one embodiment of the invention, a configurable background design sheet for attachment to a scrapbook page. The design sheet is equal or greater in width with respect to the scrapbook page. The background design sheet has a design side on the front face and a sizing side on the rear face. At least one pair of cut line indicia is disposed on the sizing side. The indicia represent the proper spacing of cut lines for the different sized scrapbook pages.

The above description sets forth rather broadly the more important features of the present invention in order that the detailed description thereof that follows may be understood, and in order that the present contributions to the art may be better appreciated. Further objects and advantages of this invention will be apparent from the following description and appended claims, reference being had to the accompanying drawings forming a part of this specification, wherein like reference characteristics designate corresponding parts in the several views. It is to be understood, however, that the drawings are designed solely for the purposes of illustration and not as a definition of the limits of the invention, for which reference should be made to the appended claims.

### BRIEF DESCRIPTION OF THE DRAWINGS

With the above and additional objects and advantages in view, as will hereinafter appear, this invention comprises the devices, combinations and arrangement of parts hereinafter described by way of example and illustrated in the accompanying drawings of preferred embodiments in which like reference characters denote similar elements throughout the several views. The figures are not drawn to scale.

FIG. 1 is a top plan view of the front face of a scrapbook design sheet according to one embodiment of the invention; and

FIG. 2 is a top plan view of the rear face of a scrapbook design sheet having first and second sizing indicia according to one embodiment of the invention.

### DETAILED DESCRIPTION OF THE INVENTION

While the foregoing discusses the use of this invention as it relates to scrapbooks, it is understood that the invention can be used in a variety of other circumstances. Some of these applications are discussed in more detail at the conclusion of the description.

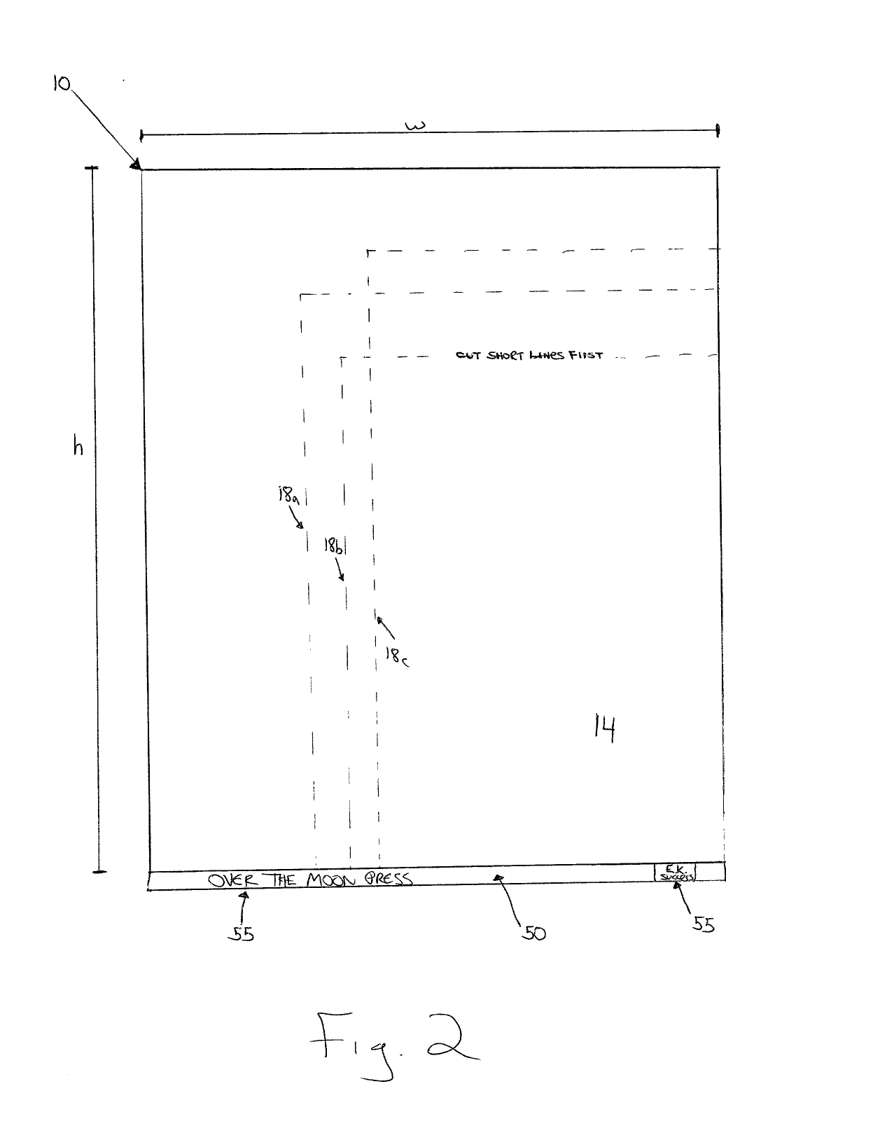

With initial reference to FIG. 2, a background design sheet 10 is shown which has a sizing side on the rear face that allows it to be more easily sized and attached to one of a variety of scrapbook pages. Conventionally, such background design sheets 10 are used in the art to decorate scrapbook pages, as discussed in more detail below. In the preferred embodiment, background design sheet 10 is fabricated from paper. As can be appreciated, however, background design sheet 10 may also be fabricated from plastic, foam, or any other material that is easily cut by a user. Notwithstanding, it is desirable that such material is capable of easily receiving printed matter thereon. Preferably, the material is acid-free and lignin-free. This follows from the prevalent desire in the art to use scrapbook materials that do not contribute to the decomposition of scrapbook contents.

Sheet 10 is comprised of four edges, of which the edges that are parallel in disposition are substantially equal in length. Sheet 10 is further made up of a design side 12 on the front face and a sizing side 14 on the rear face. Sides 12 and 14 are reversely disposed on a single sheet.

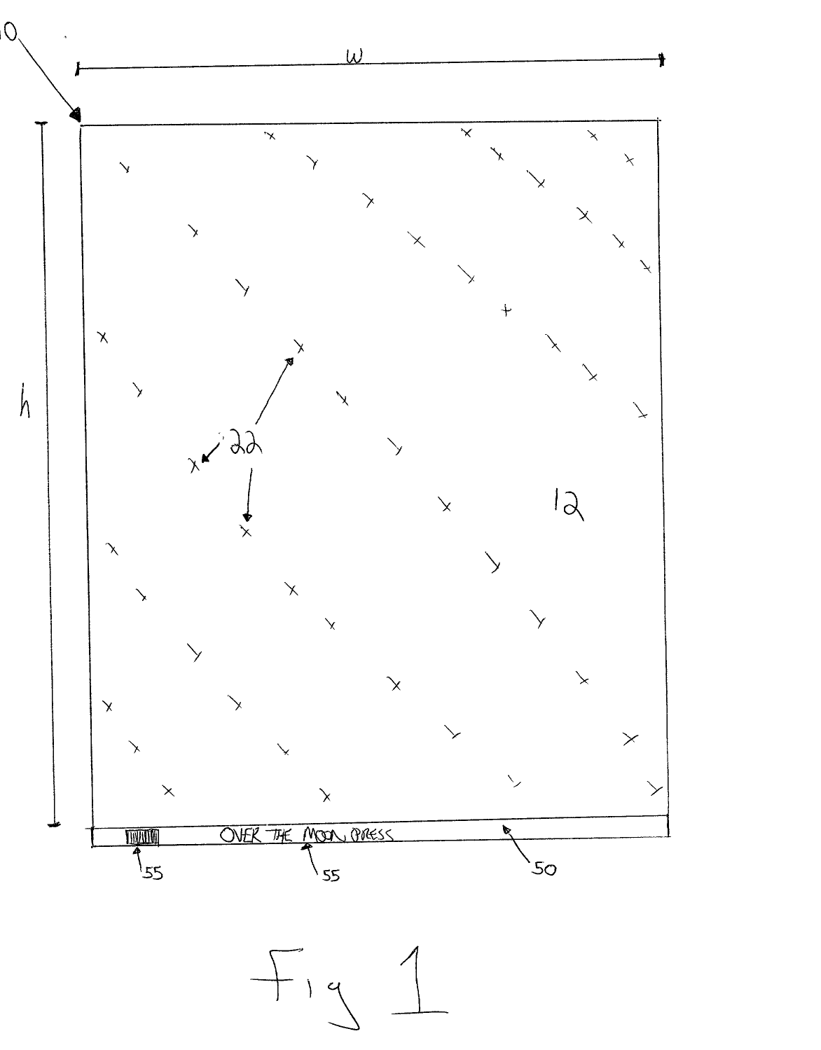

In the preferred embodiment, the overall width and height of background design sheet 10—indicated in FIGS. 1 and 2 by the letters w, and h—is 12 inches. This particular dimension represents the page width and height dimensions of one type of standard type of scrapbook. However, the overall width and height may be any reasonable length such that background design sheet 10 can be fitted on a scrapbook page. As shown, height e is approximately the same length as the width b. However, as explained below, sheet 10 may be cut along indicia lines 18 to reduce the size of the background design sheet to another size, as required by the user.

In the preferred embodiment, sizing indicia 18 are printed on the sizing portion 14. In FIG. 2, sizing indicia 18 are dashes along with textual instruction. However, it should be understood that sizing indicia may instead take the form of dots, lines, triangles, or any other appropriate markings that can indicate a position along sizing side 14. Preferably, indicia 18 are aligned so that two edges of the uncut background design sheet 10 are contiguous with the smaller size sheets formed by the indicia 18. This further facilitates use by requiring the cutting of only three lines, instead of four. Importantly, and as discussed in more detail below, the location of the sizing indicia 18 on the rear face, provides an indication for the user of potential cut positions without the use of lines or perforations to obscure the decorations 22.

In this instance, decorations 22 on design side 12 represent standard symmetrical images. One embodiment includes the use of hearts on a plain white background, diagonally aligned, so as to present an aesthetically pleasingly symmetric pattern. However, it should be understood that decorations 22 are not limited to this design. Instead, decorations 22 can represent other motifs such as other holidays, sporting events, a baby theme, and the like. In the alternative, decorations 22 may include any geometric form, or any combination of geometric forms, for example, squares, circles, triangles, rectangles, or the like (not shown). The designs are further defined as any non-geometric, asymmetrical or fanciful forms, or any combination thereof, for example animal forms, balloons, stars, vehicles, human forms (real and fictional), cartoon characters, and the like.

In one embodiment, decorations 22 are designed as small, symmetrical and repetitive so that they do not become obliterated when background design sheet 10 is cut. This also results is whole decorations 22 that can be salvaged from excess material 13, and used to further decorate a scrapbook page.

While sizing side 14, as shown in FIG. 2, includes sizing indicia 18, in one embodiment sizing side 14 may be completely blank. Such a blank sizing side 14 may provide space for a user to make markings indicating cut-lines without writing on design side 12. However, as can be appreciated, even with indicia 18, sizing side 14 can be used by user to mark additional or odd-sized cuts.

In one embodiment, an informational tab 50 can have printed thereon incidental information 55 such as brand name, price, UPC symbols, and the like. Thus another advantage of informational tab 50 is that it can contain information that would not likely be desired in final use. Information tab 50 is removed or obscured before final use. Thus, all information thereon will not show in the final product.

The manner in which background sheet 10 is utilized is now described. A user first decides on the dimensions required for decorating on a particular scrapbook page. For example, in the instance where scrapbook page dimensions are eight and one-half by eleven inches, the user utilizes indicia 18b, whereon it is indicated that the user cut along that particular indicia line for that particular size sheet to result. Excess material is then trimmed using a scissor or blade along with a straight edge; guillotine-style paper cutter; or other appropriate means. Then, the background design sheets 12 may be applied to paper surface, typically a scrapbook page, with an acid-free glue such as ZIG Memory System 2 Way Glue. The scrapbook page may now be further decorated with appropriate photographs, stickers, and written word, applied by the user, along with other items that are not shown but well known in the art.

It is understood that this invention is not limited to scrapbook use. For example sizing sides can be made part of sheets of paper that are used in a variety of situations. For example, similar sizing sides can be used for templates, on contact paper that is used in drawers and the like, wrapping paper, and many other uses that are not listed here but are easily recognized by one skilled in the art.

Therefore, a background design sheet has been shown that includes a design side on a front face, and a sizing side on a rear face. The background design sheet can be used with multiple sized scrapbook pages to provide a background upon which further decoration can be effected, resulting in a more aesthetically pleasing page.

While there has been shown and described particular embodiments of the invention, it will be obvious to those skilled in the art that changes and modifications can be made therein without departing from the invention, and therefore, the appended claims shall be understood to cover all such changes and modifications as fall within the true spirit and scope of the invention. Also it is to be understood that the phraseology and terminology employed herein is for the purpose of description and not of limitation.

What is claimed is:

1. A configurable design sheet, said design sheet comprising:
a first side having a design printed thereon, said first side having first, second, third and fourth edges, said third edge being substantially equal in length to said first edge, said second edge being substantially equal in length to said fourth edge;
an informational tab removable attached to said first edge, so that when said informational tab is removed, said first side of said configurable design sheet may be utilized as a design sheet, said first, second, third, and fourth edges being substantially equal in length; and
a second reverse side having a first cut line indicator parallel to said third edge of said first side and a second cut line indicator parallel to said fourth edge of said first side, said first and second cut line indicators together with said first and second edges of said first side define a second design sheet.

2. A design sheet as described in claim 1, wherein said at least one pair of cut line indicia form an eight and one half inch, by eleven inch, design sheet

3. A design sheet as described in claim 1, wherein said at least one pair of cut line indicia comprise dashes.

4. A design sheet as described in claim 3, wherein said at least one pair of cut line indicia further comprise textual instructions.

5. A design sheet as described in claim 1, wherein said cut line indicators define four edges such that two adjacent said edges are contiguous with two adjacent edges of the design sheet.

6. A design sheet as described in claim 1, wherein said design portion further comprises a decoration.

7. A design sheet as described in claim 6, wherein said decoration is substantially symmetrical.

8. A design sheet as described in claim 1, wherein said design sheet is fabricated from paper.

9. A design sheet as described in claim 1, wherein said design sheet is fabricated from foam.

10. A design sheet as described in claim 1, wherein said design sheet is fabricated from plastic.
